(19) United States
(12) Patent Application Publication
(10) Pub. No.: US 2009/0029841 A1
(43) Pub. Date: Jan. 29, 2009

(54) Glassware Breaking Apparatus

(75) Inventor: Oliver Monaghan, Brentford (GB)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignees: Oliver Monaghan; Paul Cummins

(21) Appl. No.: 12/225,272

(22) PCT Filed: Mar. 8, 2007
(86) PCT No.: PCT/GB2007/000798

§ 371 Date: Sep. 16, 2008

(30) Foreign Application Priority Data
Mar. 16, 2006 (GB) 0605373.0

(51) Int. Cl. C03C 3/00; B02C 19/00

(52) U.S. Cl. 501/11; 241/99

(57) ABSTRACT

A glassware-breaking machine can be used to reduce the volume of glass waste and also to reduce disposal costs. The machine can be provided with a plurality of flaps to reduce noise. In order to reduce the risk of glassware becoming jammed, a conduit can be provided with an internal cross section that increases in size in a direction towards a glassware breaking device. The glassware-breaking device may be rotatably mounted within the machine and may have a container underneath it for collecting broken glass. The machine can be of compact construction. It allows noise levels to be reduced significantly, relative to known industrial glassware-breaking machines

The present invention relates to a glassware breaking apparatus, and a method of breaking fragile or brittle items. In particular, but not exclusively, the invention relates to a bottle breaking machine.

Drinking establishments, such as pubs and bars, can turn over many glass bottles in a relatively short period. This is particularly the case during sporting events or other instances where there is a high customer demand. This can lead to the rapid accumulation of a large number of used glass bottles.

The term “drinking establishment” is used broadly herein to cover anywhere where bottled drinks are normally consumed on the premises. The drinks may be alcoholic or non-alcoholic. Licensed and non-licensed establishments are covered. Thus, in addition to pubs and bars, this term covers clubs, restaurants, theatres, cinemas, entertainment halls, cafeterias, canteens, hotels, ships, aeroplanes, railway carriages, service stations, etc.

Traditionally, empty bottles have simply been collected, temporarily stored along with other waste and then disposed of at waste tips, landfill sites, etc. However, with increasing environmental concerns, such disposal is often not permitted. It is now common practice to sort different categories of waste into separate containers. Indeed this is a requirement of many local authorities. Thus used glass bottles may be stored in separate containers from paper waste or plastic waste.

However, used glass bottles occupy a large volume relative to their density or weight, since they are empty containers. This means that waste containers can rapidly become full and may then overflow. This can be a safety hazard and is also unattractive for customers if the containers are located within a drinking establishment.

This is a particular problem in many small pubs and bars, where space for waste receptacles is severely limited. However it can be a problem in any drinking establishment, whether large or small, especially during periods of high demand.

There can also be difficulties in ensuring that there are adequate staff levels to remove full containers of used bottles (e.g. to a rear yard or another temporary storage area, prior to eventual disposal).

A further problem is that it is very costly to dispose of large volumes of glass, given that charges are often made per container. Thus disposal charges can be a significant overhead for many drinking establishments.

A still further problem is that when containers of used bottles are moved this can be noisy and can disturb customers or neighbours. This is a particular problem for late night drinking establishments in residential neighbourhoods. It can also be a problem during early mornings when bottles are collected.

Many of the foregoing problems are not unique to drinking establishments. They can apply in any situation where large volumes of used glassware need to be collected and/or moved.

Thus, for example, there can be significant problems in hospitals, laboratories, factories and workshops in disposing of used glassware.

The present invention aims to overcome or at least alleviate one or more of the foregoing problems.

According to the present invention there is provided a glassware breaking apparatus suitable for interior use, the apparatus comprising:
a housing having an inlet for receiving glassware;
a breaking device provided within the housing for breaking the received glassware; and
a collecting region for collecting broken glass.

The term “glassware” is intended to cover other brittle or fragile materials such as ceramics or brittle polymers.

Although the invention is primarily intended for use in drinking establishments, it can also be used in many other situations. It is useful for use in any situation where it is desirable for glass to be broken without extreme levels of noise.

Thus, for example, the present invention can be used in leisure or work environments where it is desired to use the machine whilst still allowing people to carry on their normal activities without undue disturbance.

For example, the machine can be used in situations where it is desired to carry on conversations at normal levels and still to be easily heard. This would simply not be possible in the proximity of prior art, industrial glassware-breaking machines.

Preferably a machine of the present invention comprises a plurality of movable and/or deformable members that a piece of glassware dropped into the inlet must contact and move past in order to reach the breaking device. Desirably these are in the form of flaps.

These members may comprise or consist of a resiliently deformable material. The material may be an elastomeric material. Preferably it is a natural or synthetic rubber material.

These members can serve to substantially reduce the noise of the machine when it is in use in breaking glassware, relative to a machine without said members.

Desirably the members (e.g. flaps) return to substantially their previous positions after a bottle has contacted and moved past them.

Preferably they are mounted so that they will normally be in a closed position, but will open under the weight of a piece of glassware passing through the machine, so as to allow the piece of glassware to move past them. Desirably they will then return to their previous positions.

Thus the members may open and close in turn as a piece of glassware passes down the machine. This can increasingly muffle sound as the piece of glassware bottle passes further into the machine.

Preferably at least two, at least three, or at least four such members are present. This represents a significant departure from prior art devices, where such flaps are normally not present.

In a preferred embodiment of the present invention at least one of said members is spring-loaded, or is otherwise urged to return to return to substantially its previous position after a piece of glassware has contacted it and moved past it. If desired, all of said members may be spring-loaded. However in many embodiments at least one of the members is not spring-loaded. A member that is not spring-loaded may be formed of flexible material (e.g. a flexible sheet) and may simply return to its previous position under gravity after a piece of glassware has contacted it and moved past it. For example, it may be a flexible flap that hangs from a mounting located within a chute. Indeed, if desired, all of the members may be non-spring loaded. This can simplify construction.

Preferably, however, a combination of at least one spring-loaded member and at least one member that is not spring-loaded is used.

The members are desirably located in a chute that is inclined at an angle to the vertical, although it possible for the chute to be substantially vertical, if desired. An angled chute is advantageous in that it can conveniently allow a hanging flexible member to operate, whereby the hanging member hangs from an inner upper surface of the chute and contacts an inner lower surface of the chute at its lower end.

The members may comprise a plurality of raised areas of resiliently deformable material. Preferably these areas are present on an upper surface that is positioned to contact a piece of glassware as it passes down the chute. The raised areas may for example be in the form of raised ridges, bumps, grids, patterns etc.

Without being bound by theory, it is possible that the provision of a plurality of raised areas may reduce impact noise, relative to a relatively flat region of deformable material. The raised areas may also be advantageous in allowing different degrees of deformation at different parts of the surface.

The members are desirably located within a chute that has inner walls of generally polygonal cross section. (For the purposes of this invention, the term “within” includes the option of a member being located at the end of the chute, if desired, although at least one member should normally be located further down the chute.)

The present inventor has found that an inner polygonal cross section is useful in reducing the likelihood of glassware becoming accidentally lodged in the chute. The polygon is preferably a regular polygon. Desirably it is a generally quadrilateral (e.g. generally square or generally rectangular).

Advantageously, the machine has a conduit that leads towards the bottle-breaking device; wherein at least part of the conduit has an inner cross section that increases in size in a direction towards the bottle-breaking device. Surprisingly even a small increase in size of the inner cross section can significantly reduce the risk of jamming.

Preferably the conduit or at least part thereof has a generally frustoconical inner wall. The diameter of the inner wall may therefore increase in a direction towards the glassware breaking device.

The frustoconical inner wall need only be offset from a cylindrical inner wall by a small angle (e.g. by less than 10 degrees, by less than 5 degrees) to be effective in reducing the likelihood of jamming. Of course a high degree of frustoconicity is also possible.

The lower end of the conduit is preferably located close to the glassware breaking device. For example it may be less than 5 cm or less than 3 cm from said device. It may even be less than 1 cm from the device. This allows a piece of glassware to be rapidly and effectively broken as it exits the conduit and facilitates smooth operation.

The breaking device is preferably rotatably mounted and comprises one or more rotatable members that break the glass. The rotatable members are desirably blades. However other possibilities exist. For example the members may be rotatably mounted rods, spikes, balls, hammers, chains, prongs, etc. Preferably the rotatably mounted members are very resilient. They are desirably formed of a hard metal (e.g. hardened steel) and/or have hardened edges (e.g. diamond edges or hardened steel edges).

The speed of rotation is preferably at least 50 rpm and is more preferably at least 100 rpm. Very high speeds can be used if desired, but normally speeds of less than 1000 rpm will be sufficient. Speeds in the range of 150 to 800 rpm may typically be used.

An arrangement of one or more rotatably mounted blades is most preferred. The blades may be replaced when desired. Alternatively they may be sharpened or repaired (e.g. by grinding) and reused.

In one embodiment the blades may be double-sided so that they can be reversed, remounted and used again. A further alternative is for them to be simply spun in an opposite direction. They may be used in combination with a reversible motor, if desired.

There are however many alternatives to a rotatably mounted device. Systems based upon crushing glass, breaking glass by a hammer action vibrating systems, etc., are all within the scope of the present invention.

The breaking device (of whatever nature) may be actuated by a sensor that senses when a bottle has been placed in the machine (or when it is being so placed). Thus the sensor may be provided transmit a signal to the breaking device and/or the motor. Several such sensors may be provided at different locations within the machine if desired. This can be useful in tracking the movement of a piece of glassware within the machine.

A sensor is preferably located at/or close to the inlet for glassware (e.g. within 20 cm or 10 cm thereof), but this is not essential and the sensor can be located further down the machine, if desired.

The sensor may comprise a beam of light or other radiation and a detector therefor. It can be conveniently positioned so that the beam of light crosses a path through which a piece of glassware would pass when placed in the machine (e.g. it may be located within a chute or other conduit).

When the beam is broken or is affected by a piece of glassware passing through the device (e.g. by being broken, refracted, diffused, changing its wavelength, etc), the actuating signal is automatically transmitted. This can be done by means of electrical wires or by wireless technology (e.g. an infra-red signal may be transmitted).

There are many other possibilities. For example a sensor may detect movement of a movable member such as a flap and may transmit a signal in response thereto.

The machine may be automatically timed so that the breaking device operates for a pre-set period for each bottle. The period may for example be less than 1 minute or even less than 30 seconds, although longer periods are possible.

Thus the machine can be arranged to switch off after the predetermined period if no further glassware is introduced during this period. This is useful in reducing energy consumption and in reducing noise still further

It is of course not essential for the breaking device to be automatically actuated by means of a sensor. It may simply be switched on or off as desired and a manually operated switch may be provided for this (or separate on and off controls may be provided).

In some circumstances the machine may be set up to run continuously. This may be done for example when it is desired to place a large number of bottles into the device over a relatively short period. For example, once many bottles have been collected from a drinking establishment a member of staff may feed them into the machine. This may for example be done at the end of a shift or may simply be done periodically during a shift once several bottles have been collected.

It is of course possible to have both manual and automatic controls and to switch the device between the two modes if desired.

The machine will normally comprise an internal motor that drives the device (although, less preferably an external motor can be provided). Any suitable motor can be used. For example a three phase motor with an inverter may be used. This has been found to be particularly quiet to operate and to be advantageous over a single phase motor.

In one embodiment the motor is mounted at one side of a platform and the breaking device is mounted at the other side of a platform, the platform further comprising an aperture through which bottles pass to be broken.

The device may be connected to a suitable mains power supply, e.g. an electric socket, and may be provided with a plug for this purpose.

Alternatively, it may be connected to a generator; it may be powered by an internal battery; or may even be provided with a fuel driven motor. It may therefore be used in circumstances where mains electricity is not present and may be highly portable. Thus although the machine is suitable for interior use, it is not limited to such use and can also be used for outdoor events, such as festivals, concerts, outdoor sporting events, etc. (It provides the same advantages here, in that it can be operated relatively quietly, it can be provided in compact form and it can reduce the cost and inconvenience of disposing of glassware.)

The machine may comprise a container for collecting broken glass. Preferably the container is removable. The machine may also comprise an indicator that indicates when the container has received a given amount of broken glass (e.g. a given volume or weight of glass), although this is not essential.

For example, once a given weight of glass has been received by the container, or once the glass in the container has passed a certain level, then the indicator may operate. Any appropriate means of indication (e.g. a sound or light) may be actuated.

Alternatively, an operator may periodically check the container to ascertain when it should be emptied. This may for example be done by opening a door and inspecting the container by eye (when the machine is not in use).

In a further embodiment the container may be viewable from outside the machine so that it can be seen without needing to open a door. Thus, for example, part of the machine (e.g. a door or window) may be provided that is transparent or translucent.

In another alternative, the machine may be provided with measuring means that indicate the weight of glass in the container. An operator may decide based upon the weight indicated whether or not to empty the container. The measuring means may indicate the weight mechanically or by an electronic display. The measuring means may indicate the actual weight of glass in the container or may indicate when the weight of glass has reached a predetermined threshold weight.

The container may optionally comprise wheels, castors, rollers or other aids to movement. This can make it easier to move the container in or out of the machine, although, although this is not essential. The container may even be in the form of a drawer that can easily be slid in or out of the machine.

A disposable container may also be provided and may be placed in the container of the machine. For example, a flexible sack or bag for collecting broken glass may be placed therein. It may be secured by catches, ties or other securing means, but this is usually not necessary.

The elegant design of a machine of the present invention allows it to be provided in a compact form. Thus it is preferably less than 2.0 metres high. More preferably, it is less than 1.75 or less than 1.5 metres tall. Most preferably, it is less than 1.25 metres tall.

Desirably it is less than 1 metre wide in (in its maximum width). More desirably it is less than 0.75 metres wide. Most preferably it is less than 0.60 metres wide. The machine can therefore be significantly smaller than prior art industrial machines.

The machine may be provided with sound-proofing insulation. For example it may be provided with one or more sound-insulating layers; with one or more sound-insulating covers or surrounds and/or with sound insulating packing.

Sound-insulating material is well known and is available from many builders' merchants for example. It may be in the form of foam, sheets, wadding, fleece, laminates, packing, etc. It is even possible to encase the machine or a substantial part of it with sound-insulating casing, although this will not normally be necessary.

Such material further reduces the noise of the machine (in addition to the sound insulation that can be provided by flaps or other components).

Preferably the machine operates at less than 100 decibels. More preferably, it operates at less than 80 decibels, less than 75 decibels, or less than 70 decibels. Most preferably, it operates at less than 60 decibels, or less than 50 decibels. (The sound emitted can be measured by a person with a sound detector standing at a distance of 1 metre from the machine.)

The machine is very effective at reducing the volume of glassware. Preferably, it reduces the volume to less than a quarter of its original volume. More preferably it reduces it to less than a fifth, less than a sixth, less than a seventh or less than an eighth.

The broken glass produced by the machine will typically be in the form of small glass pieces known as cullets. These can be used commercially for recycling, as filling materials, or for other purposes. If desired the cullets may be collected periodically. A special collecting service may be provided for this purpose.

It is possible to further reduce the glass to a powder-like material (similar to sand) by using the machine at high rpm levels. However for most purposes it is preferred to reduce the glass down to the size of cullets.

The broken glass (in whatever form) may be washed and/disinfected or sterilised. This can be particularly important if the glassware is hospital or laboratory waste. In specialised embodiments the machine may be arranged to perform these functions. For example, it may be provided with a washing chamber and may also be provided with a source of heat or radiation (e.g. microwave radiation or UV light) to kill harmful pathogens. However it is generally preferred that these functions are performed elsewhere.

The machine is in any event useful in processing hospital or laboratory sharps. It can significantly reduce the high cost of disposal by reducing the volume of sharps significantly. Furthermore, because the sharps can be reduced to small cullets or even to powder, the risk of accidental injury is minimised.

In addition to the machine itself, the present invention includes a method of breaking a piece of glassware.

Broken glass that has been obtained by this method is also within the scope of the present invention. The broken glass is preferably recycled or reused for some other purpose. If desired it may be melted down and formed into new objects (e.g. new bottles or other glassware). Such objects are also within the scope of the invention.

As indicated earlier, the machine is particularly useful for use in a drinking establishment, although it is not limited to such use. It can be conveniently located behind a bar but may also be located in any desired location (e.g. a customer area). The device can be operated safely and easily. It may be used by staff or customers, although it is anticipated that staff will normally use the machine.

Preferably it operates sufficiently quietly so that customers in the establishment can have conversations without having to raise their voices above normal levels in order to be heard above the machine. The device will normally be connected to a suitable mains power supply, e.g. an electric socket.

It may optionally be provided with wheels, castors or other movable members so that it can be conveniently moved. It may also be provided with a brake if desired. In some cases it may be fixed to a wall or other structure (e.g. by a bracket) but this is normally not necessary.

The device is preferably placed on a substantially level surface. It may be fitted with a spirit level or other indicator of levels, but this is not usually necessary.

The present invention will now be described by way of example only, without limitation thereof, wherein:

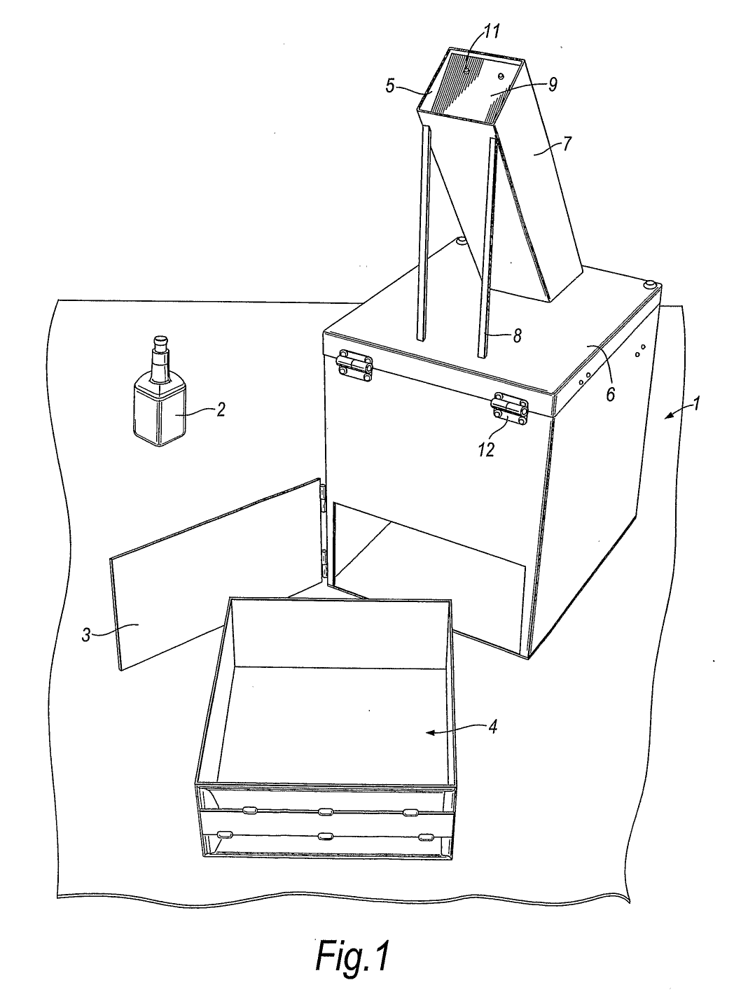

FIG. 1 shows a bottle-breaking apparatus according to a first embodiment of the present invention in perspective view with an inner container removed. The view is shown from the front and to one side;

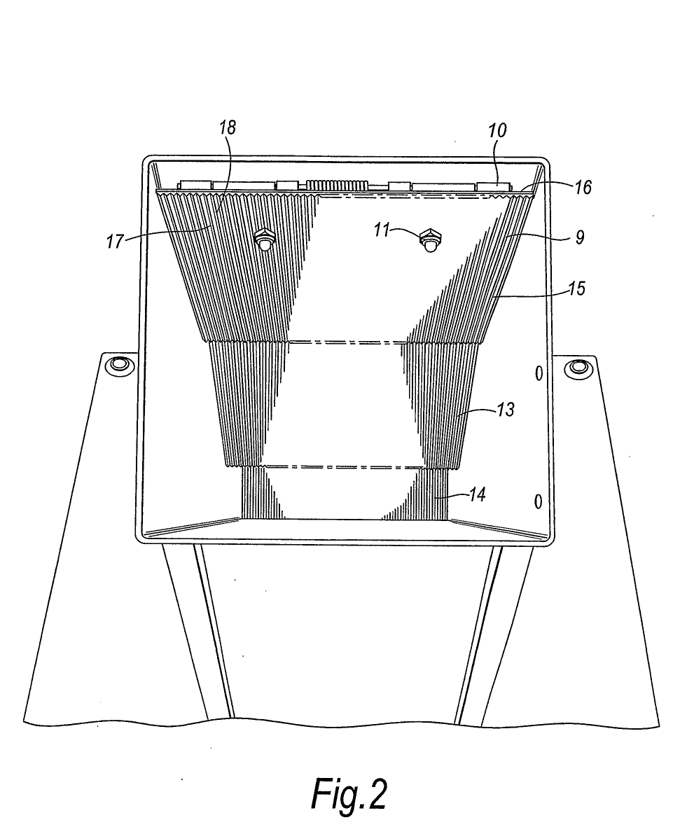

FIG. 2 shows a partial top view of the apparatus shown in FIG. 1, looking down into a chute of the machine;

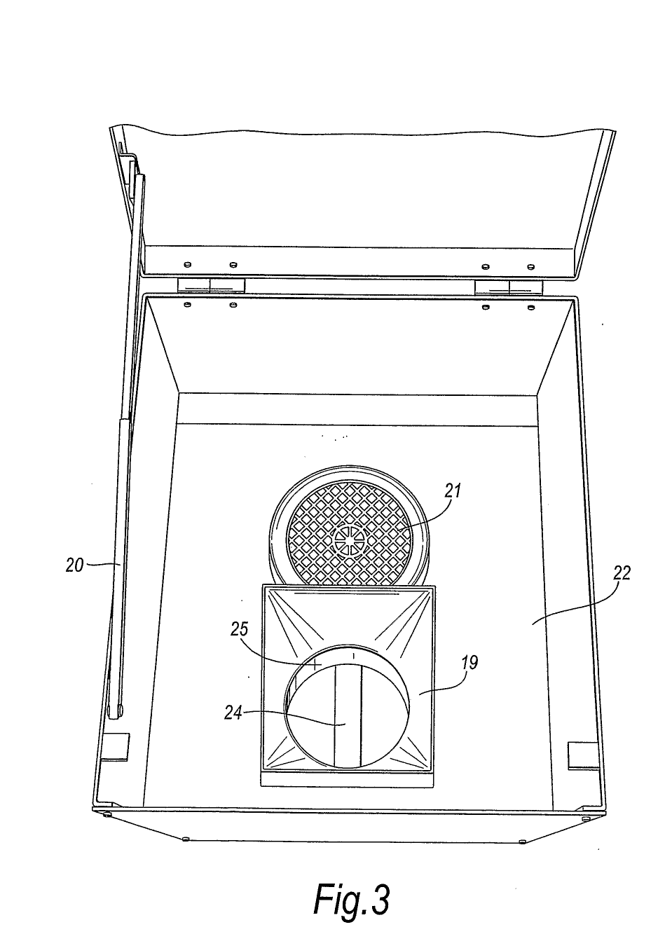

FIG. 3 shows the apparatus shown in FIGS. 1 and 2 with a lid open and pivoted back so as to expose a platform that is connected to a motor and also to show a hopper;

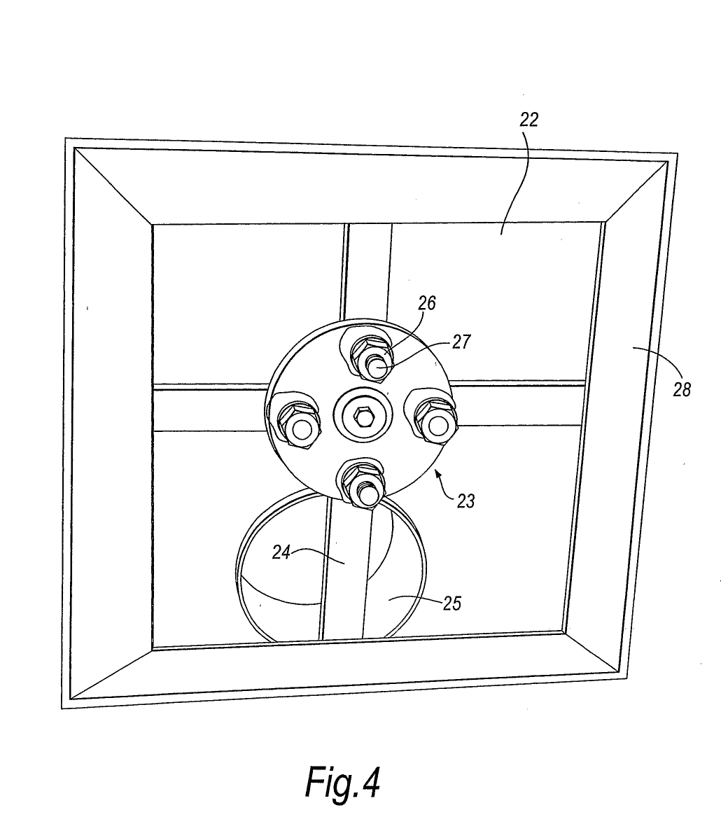

FIG. 4 shows a view from the underside of the platform that is shown in FIG. 3;

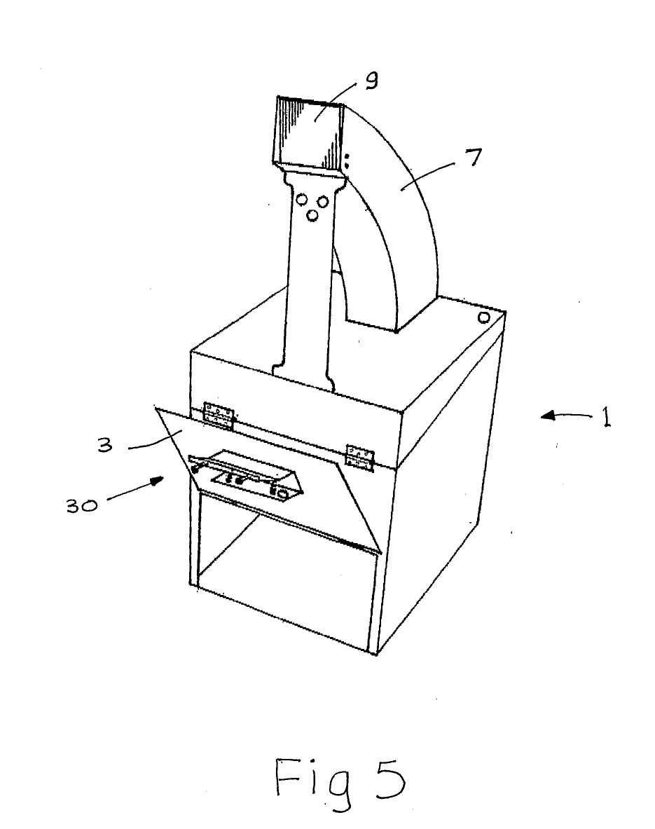

FIG. 5 shows a bottle-breaking apparatus according to a second embodiment of the present invention in perspective view; and

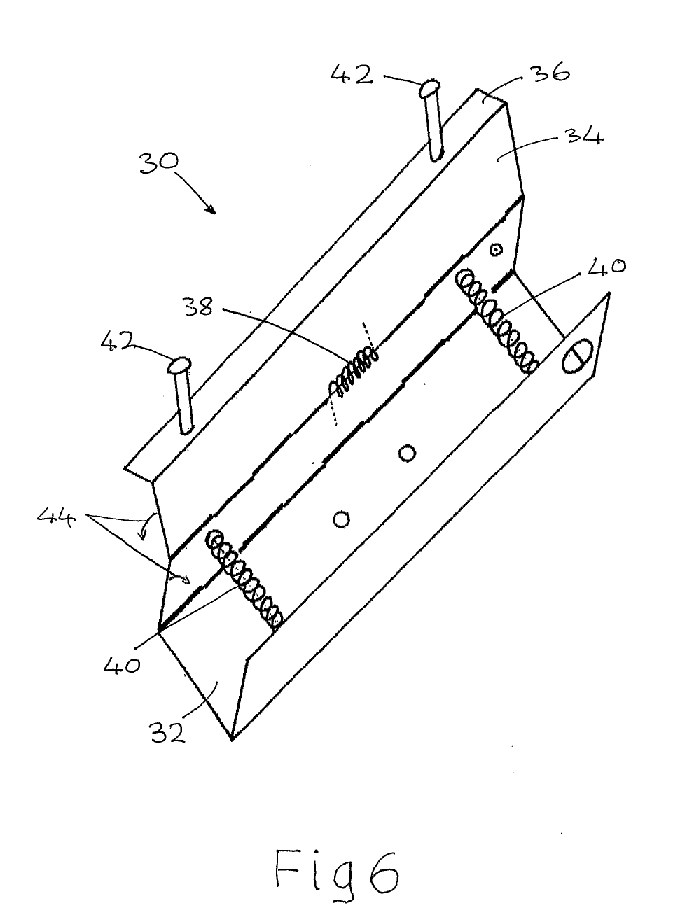

FIG. 6 shows a perspective view of a lifting and weighing component of the apparatus shown in FIG. 5.

### EXAMPLES

Referring now to FIG. 1, a bottle breaking machine 1 of the present invention is shown next to a 1.5 litre bottle of Jack Daniel's™ whiskey 2 (to illustrate the scale).

The machine 1 is shown with its door 3 open and an inner container 4 of the machine removed. A bag (not shown) will usually placed in this container 4 and used to collect broken glass, although it is possible to use just a container alone (without a bag).

The machine 1 has a top 6 that is pivotally mounted to the main body of the machine by means of hinges 12. The hinges 12 allow the top 6 to be pivoted back when the machine 1 is not in use, for ease of maintenance (as described later with reference to FIG. 3).

The top 6 carries an angled chute 7 into which bottles to be broken can be placed by a user of the machine 1. The chute 7 carries a sensor (not shown) which senses when a bottle is placed in the chute & and actuates a motor of the device. Struts 8 contain wiring that is used for the sensor and for transmitting the signal. Typically the sensor will sense when a beam passing across the chute is interrupted by a piece of glassware passing down the chute 7.

A flap 9 is shown at the top of the chute 7. This is the first of a series of flaps 9, 13, 14, which are described later with reference to FIG. 2. The flap 9 is connected to a hinge 10 (not visible in FIG. 1, but shown in FIG. 2). This is achieved by nuts 11 and bolts. Thus the flap 9 can be easily removed for maintenance or replacement.

The hinge 10 is spring-loaded so that the flap 9 is normally urged in an upwards direction to substantially close the chute 7 (when the machine 1 is not in use). FIG. 1 shows the flap 9 in this closed position.

However, when the machine 1 is in use, the flap 9 moves downwards to an open position under the weight of a bottle placed into the chute 7. This allows the bottle to fall past the flap 9 under the influence of gravity. When the bottle has passed down the chute 7 the flap 9 returns to its closed position (unless a further bottle has subsequently been placed in the chute 7).

The inner wall of the chute 7 is substantially square in cross-section. This reduces the likelihood that a bottle of round cross-section will become accidentally jammed in the chute 7.

The flap 9 is shaped to provide a close fit within the chute 7 when the flap 9 is in the closed position. It may bear against one or more internal surfaces of the chute. The flap 9 is useful in reducing the level of noise emitted from the machine 1. Indeed several flaps 9,13, 14, will normally be mounted in series in the chute 7 so as to provide a significant degree of noise reduction.

The flap 9 can also act as a safeguard that will prevent broken glass from exiting the machine 1 via the inlet to chute 7. However, due to the design of the machine 1, it is already very safe and there is very little likelihood that glass pieces would reach this part of the machine. This safety feature may therefore provide further reassurance for a customer but is unlikely to be needed in practice to prevent glass pieces from exiting via the inlet to the machine. Its prime function is therefore noise reduction (although in some embodiments a sensor may be operably linked to the flap 9 and may actuate a bottle-breaking device 23 within the machine 1 when the flap 9 has been moved by a bottle).

Turning now to FIG. 2, three flaps 9, 13, 14 are shown that are located within the chute 7 are shown. A fourth flap is also present, but is located further down the chute 7 and is therefore not visible in this figure. These flaps are shown in an open position, as would occur when a bottle passes down the chute 7, but would normally be closed unless a bottle is passing down the chute.

The first flap 9 is the same flap as is shown in FIG. 1. It has an upper region 15 of resiliently deformable rubber material and a lower metal plate 16 that is pivotally mounted to a hinge 10 via nuts 11 and bolts. The hinge 10 is spring-loaded to urge the flap 9 in an upwards direction so that it will normally close the chute 7. The deformable material 15 serves to cushion the impact of a bottle on the flap and thereby to reduce noise. The relatively rigid plate 16 maintains the shape of the flap 9.

It can be seen from FIG. 2 that a series of parallel grooves 17 and ridges 18 are present in the deformable material 15. When a bottle contacts the flap 9 different ridges 18 can deform to a different degree (depending upon the nature and position of the impact of the bottle on the flap). Without being bound by theory, this may be useful in reducing impact noise and /or in allowing increased deformation to occur.

The first flap 9 is displaced by the weight of the bottle and the bottle then moves down towards the second flap 13. The second flap 13 and subsequent flaps 14 are formed of rubber and have the grooves and ridges as described earlier. However these flaps 13, 14 are relatively flexible because they are not attached to rigid base plates. They are also not mounted by spring-loaded hinges. They are simply attached to the upper wall of the chute 7 (e.g. by screws, nuts and bolts or adhesive) and hang down so that they are normally in the closed position. They are therefore shaped so that they hang in this position and have lower edges that will normally contact the lower inner wall of the chute 7 or will lie very close thereto.

However under the weight of a bottle moving down the chute 7 these flexible flaps 13, 14 move to allow the bottle past and then return to their original positions following deformation. The rubber material of which they are formed is resilient and can allow this action to occur many times without undue wear.

The flaps 9,13, 14 can overlap with one another slightly. However in most instances this is not preferred and the flaps 9, 13, 14 will be spaced apart so that one flap does not contact another flap.

The flaps 9, 13, 14 close after a bottle has moved past them. Thus if four flaps are present there are four closed flaps by the time that the bottle has descended towards a bottle-breaking area of the machine. The closed flaps provide a high degree of sound insulation. The body of the machine 1 is also packed with sound-insulating material (not shown).

In the embodiment shown in FIGS. 1 to 4, the chute 7 leads down towards a hopper 19. The hopper 19 is inside the body of the machine 1 and can only be seen in FIG. 3. The hopper 19 may have a rubber or other deformable material on its upper surface to further reduce noise, if desired. However, this is not essential, because the hopper 19 is located deep within the machine 1.

FIG. 3 shows a view of the machine 1 with its top 6 pivoted about hinges 12 and held in that position by an extended retaining arm 20. This exposes the hopper 19, as well as the cover of a motor 21. The motor 21 is attached to a platform 22. Underneath the platform a bottle breaking device 23 is rotatably mounted and is driven by a motor 21.

Part of a blade 24 of the bottle breaking device 23 can be seen in FIG. 3 (although a better view of the device 23 is shown in FIG. 4, as will be described later). FIG. 3 also shows a conduit 25 into which the hopper 19 leads. The conduit 25 leads towards a region where bottles are broken by the bottle breaking device 23.

The conduit 25 increases slightly in diameter from its top towards its bottom. Thus it has a greater diameter at the bottom than at the top and is frustoconical in shape. The present inventor has found that this shape reduces the likelihood of bottles becoming jammed (compared to a conduit of regular cross section).

Surprisingly, even a relatively small increase in the diameter of the conduit 25 in the direction towards the bottle-breaking device 23 can significantly reduce the risk of bottles becoming jammed in this part of the machine 1.

Turning now to FIG. 4, this shows a view from inside the machine looking up towards the underside of the platform 22 (with the container 4 removed). Thus this is a view from the opposite side of the platform 22 to that shown in FIG. 3.

FIG. 4 therefore shows the frustoconical conduit 25 from below, with the widest part of the conduit 25 being located closest to the viewer. FIG. 4 shows the bottle-breaking device 23 in greater detail than is shown in the other figures. In this embodiment it comprises four blades 24 that are rotatably mounted about a vertical axis. This axis is offset from another vertical axis passing through the conduit 25.

The blades 24 of the bottle-breaking device can be conveniently removed and replaced by virtue of removable nuts 26 that are attached to bolts 27.

As an alternative to replacing the blades 24 they may be sharpened after they have become worn. The blades 24 can be formed of any suitable hard-wearing material, such as hardened steel. Their edges may be hardened, if desired (e.g. by tempering or by incorporating small diamonds or other hard material.)

A downwardly angled frame 28 is shown that is positioned to rest on internal ledges of the machine 1. The frame 28 is connected to the platform 22, to which the motor 21 is also mounted. In practice, the platform 22, frame 28, motor 21, and bottle-breaking device 23 may conveniently be formed as a unit that can be easily removed from the machine 1 for maintenance. The hopper 19 may also be part of this unit or may be removably mounted to the unit.

In use, a bottle is placed or dropped into the chute 7. The bottle passes a sensor (not shown), which actuates the motor 21 and the bottle breaking device 23 for a predetermined period (e.g. 20 seconds).

The bottle passes down the chute 7 in a controlled manner, contacting and displacing the flaps 9, 13, 14 within the chute 7 as it does so. The noise of the bottle is muffled as it passes down the chute 7, because successive flaps 9, 13, 14 close once the bottle has moved past them. If desired, the inner walls of the chute 7 may also comprise a noise reducing material (e.g. a rubber coating) to cut down noise still further.

The bottle eventually reaches the hopper 19, which then directs it towards the frustoconical conduit 25. As the bottle exits the conduit 25, it passes down towards rotating blades 24 of the bottle-breaking device 23. These blades 24 are located very close to the outlet of the conduit 25 and they rapidly break the bottle into small cullets. The cullets are collected in the bag (not shown) located in container 4.

The machine stops after the predetermined period has elapsed, but will start again if further bottles are placed in the chute 7.

The machine 1 can easily be emptied by opening the door 3, removing the bag of cullets from the container 4, replacing it with an empty bag, placing the container with the empty sack back in the machine and closing the door 3. A collection service for collecting the cullets may be provided. The cullets can thus be conveniently disposed of or recycled.

The height of the machine 1 illustrated is about 46 inches (from its base to the top of the chute 7). The machine 1 and it has a width of about 19 inches in one direction and 20½ inches in the other direction. Many other shapes and sizes are of course possible and these dimensions simply provide one example of a compact design (relative to large industrial machines).

FIGS. 5 and 6 show a second embodiment of the invention and like features are given like reference numerals.

In this embodiment, the chute 7 is arcuate which eliminates any corners which could impede the path of bottles 2 travelling down the chute 7. Also, although not apparent from FIG. 5, the inner wall of the chute 7 is substantially square in cross-section at an upper region of the chute 7. However, this gradually alters along the length of the chute 7 until the inner wall of the chute 7 is substantially circular in cross-section at a lower region of the chute 7. The square cross-section at the upper region of the chute 7 allows square flaps to be used which deform more evenly. The circular cross-section at the lower region of the chute 7 maintains the orientation of bottles 2 travelling down the chute 7 and also minimises the risk of bottles jamming in the chute 7.

The apparatus of this embodiment also includes a lifting and weighing component 30. The component 30 comprises a plate having a number of folds or bends to produce a ‘C’ section 32 with an adjoining flange 34 and lip 36. A first spring 38 has a first end connected to the C′ section 32 and a second end connected to the flange 34. Second and third springs 40 are provided between the upper and lower plates of the C′ section 32. Two lifting protrusions 42 are provided at the lip 36.

When the door 3 is closed, the lifting protrusions 42 of the component 30 engage and lift the inner container 4 so that it is sealed to the base of the hopper 19. This prevents any spillages from the inner container 4. As the inner container 4 fills, the weight causes the flange 34 to rotate relative to the top plate of the C′ section 32 as shown by the arrows 44 of FIG. 6. This causes torsion of the first spring 38. A sensor (not shown) measures the displacement of the first spring 38 and sends a signal to indicating means, such as an LED (not shown), when the displacement reaches a threshold value. The first spring 38 could be replaced by a potentiometer or other suitable device.

Of course many other variants of the present invention are possible apart from the embodiments described with reference to the foregoing specific examples, as will be apparent to the person skilled in the art. These variants are all within the scope of the present invention.

A machine of the present invention can be used for breaking down any type of article such as glassware to a smaller volume. Normally the article will be used (e.g. a used glass bottle or glass that has been used for medical purposes). However it is not essential for the article to be used. It may for example be damaged or simply not wanted.

In the case of drinking establishment the glassware will normally be used bottles that have contained alcoholic or non-alcoholic beverages. Indeed a bottle may contain some beverage within it (e.g. a half finished bottle of beer) and can still be placed into a machine of the present invention and disposed of. (Here it is preferred that the machine is provided with a water impervious container.) Alternatively the bottles may be emptied and/or washed prior to disposal, but this is not essential.

Large and/or small bottles can be disposed of. Thus bottles of spirits wine, beer, alcopops, cider, soft drinks, water, etc., may be disposed of. Indeed broken glasses may also be conveniently disposed of desired.

The machine of the present invention is therefore extremely versatile and represents a major advance in glassware disposal.

1. A glassware breaking apparatus suitable for interior use, the apparatus comprising:
a housing having an inlet for receiving glassware;
a breaking device provided within the housing for breaking the received glassware; and
a collecting region for collecting broken glass.

2. An apparatus according to claim 1, wherein the apparatus is a bottle breaking machine and is suitable for use in a drinking establishment.

3. An apparatus according to claim 1, including at least one movable and/or deformable member located at or near the inlet such that a piece of glassware dropped into the inlet must contact and move past the member in order to reach the breaking device.

4. An apparatus according to claim 3, wherein one or more of the members comprise a flap.

5. An apparatus according to claim 3, wherein one or more of the members comprises a resiliently deformable material.

6. An apparatus according to claim 5, wherein said material comprises an elastomeric material.

7. An apparatus according to claim 5, wherein the material comprises a natural or synthetic rubber.

8. An apparatus according to claim 3, wherein one or more of the members is adapted to substantially reduce the noise of the apparatus when it is in use in breaking glassware, relative to an apparatus without said members.

9. An apparatus according to claim 3, wherein one or more of the members are resilient such that they return to their previous positions after a piece of glassware has contacted and moved past them.

10. An apparatus according to claim 3, wherein one or more of the members are normally in a closed position and open under the weight of a piece of glassware passing through the apparatus.

11. An apparatus according to claim 3, wherein at least one of said members includes biasing means for returning the or each member to substantially its previous position after a piece of glassware has contacted and moved past it.

12. An apparatus according to claim 3, wherein at least one of said members returns to its previous position under gravity after a piece of glassware has contacted it and moved past it.

13. An apparatus according to claim 3, wherein the members comprise a plurality of raised areas of resiliently deformable material.

14. An apparatus according to claim 3, wherein the members are located in a chute that has inner walls of generally polygonal cross section.

15. An apparatus according to claim 14, wherein said cross section is generally square.

16. An apparatus according to claim 3, wherein the members are located in a chute that has inner walls of generally polygonal cross section at an upper region of the chute and has inner walls of generally circular or elliptical cross section at a lower region of the chute.

17. An apparatus according to claim 1, including a sensor, wherein the sensor senses the presence of a piece of glassware that has entered or is entering the apparatus and provides a signal to actuate the glassware breaking device in response thereto.

18. An apparatus according to claim 17, wherein the glassware breaking device is automatically switched off after a predetermined period of time.

19. An apparatus according to claim 18, wherein said period is extended if a further piece of glassware enters the apparatus whilst the device is still running.

20. An apparatus according to claim 1, wherein the glassware breaking device is rotatably mounted and comprises one or more rotatably mounted blades.

21. An apparatus according to claim 1, including a motor, wherein the motor drives the glassware breaking device, and wherein the motor is mounted at one side of a platform and the glassware breaking device is mounted at the other side of a platform, the platform further comprising an aperture through which glassware to be broken passes.

22. An apparatus according to claim 1, including a container for collecting broken glass.

23. An apparatus according to claim 22 including a weighing component for weighing the weight of glass within the container.

24. An apparatus according to claim 22 including an indicator for indicating when the container has received an amount of broken glass.

25. An apparatus according to claim 22 including means for lifting the container such that it abuts a portion of the housing.

26. An apparatus according to claim 1, wherein the apparatus is less than 2 metres tall.

27. An apparatus according to claim 26, wherein the apparatus is less than 1.5 metres tall.

28. An apparatus according to claim 1, wherein the apparatus is less than 0.6 metres wide.

29. An apparatus according to claim 1, including a conduit that leads towards the glassware-breaking device, and wherein at least part of the conduit has an inner diameter that increases in a direction towards the glassware breaking device.

30. An apparatus according to claim 29, wherein said conduit or at least part thereof is generally frustoconical in shape.

31. An apparatus according to claim 29, wherein the lower end of the conduit is less than 3 cm above the glassware breaking device.

32. An apparatus according to claim 31, wherein the lower end of the conduit is less than 1 cm above the glassware-breaking device.

33. An apparatus according to claim 29, wherein at least a portion of the conduit is substantially arcuate.

34. An apparatus according to claim 1, including one or more sound-insulating layers or one or more sound-insulating covers or surrounds.

35. An apparatus according to claim 1, including sound insulating packing.

36. An apparatus according to claim 1, including sound insulating inserts.

37. An apparatus according to claim 1, wherein the apparatus is capable of reducing the volume of glassware to a fifth or less of its original volume.

38. (canceled)

39. Glass pieces made using the apparatus of claim 1.

40. Glass pieces according to claim 39, wherein the glass pieces are in the form of cullets.
